(19) United States
(12) Patent Application Publication
(10) Pub. No.: US 2024/0132326 A1
(43) Pub. Date: Apr. 25, 2024

(54) REMOTE ELEVATOR MONITORING SYSTEM, USER MANAGEMENT METHOD IN REMOTE ELEVATOR MONITORING SYSTEM, AND STORAGE MEDIUM

(71) Applicant: Mitsubishi Electric Corporation, Tokyo (JP)

(72) Inventor: Masayuki SATO, Tokyo (JP)

(73) Assignee: Mitsubishi Electric Corporation, Tokyo (JP)

(21) Appl. No.: 18/277,584

(22) PCT Filed: Mar. 23, 2021
(86) PCT No.: PCT/JP2021/012372

§ 371 Date: Aug. 16, 2023

(51) Int. Cl. B66B 5/00; B66B 1/34; B66B 1/46; G06F 21/31

(52) U.S. Cl. CPC B66B 5/0018; B66B 1/3407; B66B 1/468; G06F 21/31; B66B 1/3438; B66B 1/3461

(57) ABSTRACT

A remote monitoring system includes a registration accepting part and a setting part. The registration accepting part accepts registration information. The registration information represents registration of a second user as a child user of a first user being registered in a user management table. A first table associates a browsable monitoring range with each user. When the registration accepting part accepts registration information, the setting part sets a monitoring range which can be browsed by the second user as a child user of the first user to a range not exceeding a browsable monitoring range which is associated with the first user in the user management table.

### TECHNICAL FIELD

The present disclosure relates to a remote elevator monitoring system, a user management method in a remote elevator monitoring system, and a user management program.

### BACKGROUND ART

PTL 1 discloses an example of a remote elevator monitoring system. In the remote monitoring system, a judgment is made as to whether or not a user who requests to browse monitoring data is a user authenticated to browse the monitoring data.

### PRIOR ART

### Patent Literature

[PTL 1] Japanese Patent No. 4826687

### SUMMARY OF THE INVENTION

### Problem to be Solved by the Invention

In a remote elevator monitoring system, an operator performing monitoring work may ask another operator to fill in to perform the monitoring work. In this case, there is a possibility that the requested operator is not permitted to browse monitoring data which the requesting operator is permitted to browse. In the remote monitoring system according to PTL 1, in order to enable the requested operator to fill in, registration of a new user who is authenticated to browse the monitoring data is necessary. Therefore, filling in to perform monitoring work can prove to be difficult.

The present disclosure is related to a solution of such a problem. The present disclosure provides a remote monitoring system which can make it easy to fill in to perform monitoring work of an elevator, a user management method of the remote monitoring system, and a user management program.

### Means to Solve the Problem

A remote elevator monitoring system according to the present disclosure includes: a registration accepting part which accepts registration information representing registration of a second user as a child user of a first user being registered in a first table which associates a browsable monitoring range with each of a plurality of users; and a setting part which, when the registration accepting part accepts the registration information, sets a monitoring range which can be browsed by the second user as a child user of the first user to a range not exceeding a browsable monitoring range which is associated with the first user in the first table.

A remote elevator monitoring system according to the present disclosure includes: a storage part which stores a first table which associates a browsable monitoring range with each of a plurality of users; a registration accepting part which accepts registration information representing registration of a second user as a child user of a first user being registered in the first table; and a setting part which, when the registration accepting part accepts the registration information, sets a monitoring range which can be browsed by the second user as a child user of the first user to a range not exceeding a browsable monitoring range which is associated with the first user in the first table.

A remote elevator monitoring system according to the present disclosure includes: a registration accepting part which accepts registration information representing registration of a second user as a child user of a first user being registered in a first table which associates a browsable monitoring range with each of a plurality of users; a setting part which, when the registration accepting part accepts the registration information, sets a monitoring range which can be browsed by the second user as a child user of the first user to a range not exceeding a browsable monitoring range which is associated with the first user in the first table; and a storage part which stores a second table which associates a browsable monitoring range set by the setting part with a child user registered based on the registration information.

A user management method in a remote elevator monitoring system according to the present disclosure includes: a registration accepting step of accepting registration information representing registration of a second user as a child user of a first user being registered in a first table which associates a browsable monitoring range with each of a plurality of users; and a setting step of setting, based on the registration information accepted in the registration accepting step, a monitoring range which can be browsed by the second user as a child user of the first user to a range not exceeding a browsable monitoring range which is associated with the first user in the first table.

A user management program according to the present disclosure causes a remote elevator monitoring system to execute: a registration accepting step of accepting registration information representing registration of a second user as a child user of a first user being registered in a first table which associates a browsable monitoring range with each of a plurality of users; and a setting step of setting, based on the registration information accepted in the registration accepting step, a monitoring range which can be browsed by the second user as a child user of the first user to a range not exceeding a browsable monitoring range which is associated with the first user in the first table.

### Effects of the Invention

The remote monitoring system, the user management method of the remote monitoring system, or the user management program according to the present disclosure can make it easy to fill in to perform monitoring work of an elevator.

### BRIEF DESCRIPTION OF DRAWINGS

FIG. 1 is a configuration diagram of a remote monitoring system according to a first embodiment.

FIG. 2 is a diagram showing an example of a monitoring data table which is stored in a storage part according to the first embodiment.

FIG. 3 is a diagram showing an example of a user management table which is stored in the storage part according to the first embodiment.

FIG. 4 is a diagram showing an example of a child user management table which is stored in the storage part according to the first embodiment.

FIG. 5 is a diagram showing an example of display in a monitoring terminal of the remote monitoring system according to the first embodiment.

FIG. 6 is a diagram showing an example of display in the monitoring terminal of the remote monitoring system according to the first embodiment.

FIG. 7 is a diagram showing an example of a table which is processed in the remote monitoring system according to the first embodiment.

FIG. 8 is a diagram showing an example of a table which is processed in the remote monitoring system according to the first embodiment.

FIG. 9 is a diagram showing an example of a table which is processed in the remote monitoring system according to the first embodiment.

FIG. 10 is a diagram showing an example of a table which is processed in the remote monitoring system according to the first embodiment.

FIG. 11 is a flowchart showing an example of operations of the remote monitoring system according to the first embodiment.

FIG. 12 is a flowchart showing an example of operations of the remote monitoring system according to the first embodiment.

FIG. 13 is a flowchart showing an example of operations of the remote monitoring system according to the first embodiment.

FIG. 14 is a flowchart showing an example of operations of the remote monitoring system according to the first embodiment.

FIG. 15 is a flowchart showing an example of operations of the remote monitoring system according to the first embodiment.

FIG. 16 is a flowchart showing an example of operations of the remote monitoring system according to the first embodiment.

FIG. 17 is a hardware configuration diagram of substantial parts of the remote monitoring system according to the first embodiment.

### DESCRIPTION OF EMBODIMENTS

Modes for carrying out the object of the present disclosure will be described while referring to the accompanying drawings. Same or corresponding portions in each drawing will be denoted by same reference signs and overlapping descriptions thereof will be simplified or omitted as deemed appropriate. It is to be understood that the object of the present disclosure is not limited to the following embodiments and any of the components of the embodiments can be modified or any of the components of the embodiments can be omitted without departing from the spirit of the present disclosure.

### First Embodiment

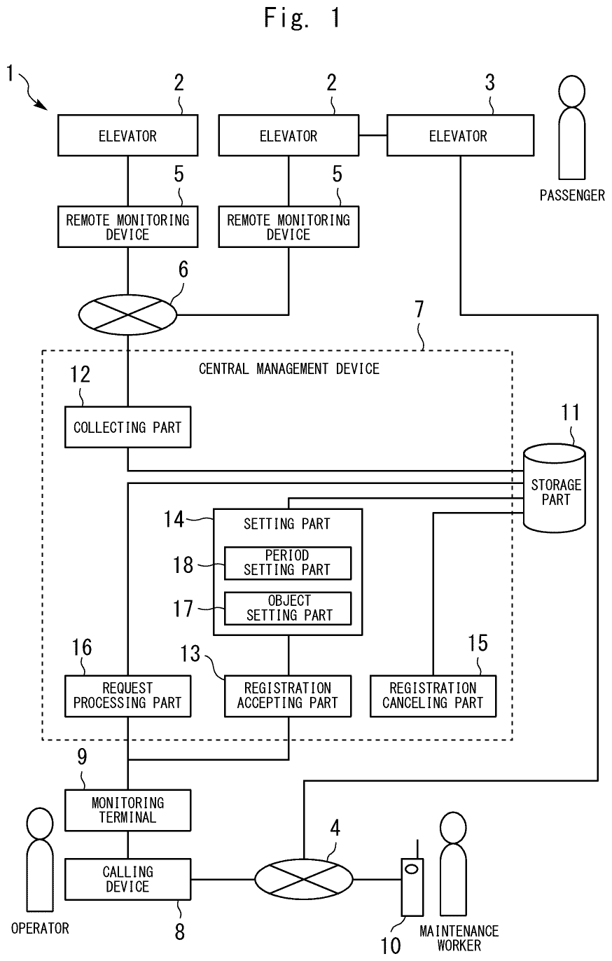

FIG. 1 is a configuration diagram of a remote monitoring system 1 according to a first embodiment.

The remote monitoring system 1 is applied to remote monitoring with a plurality of elevators 2 as objects of monitoring. For example, the elevators 2 are applied to a building with a plurality of floors. The elevators 2 are devices which, by causing a car (not illustrated) to run in an up-down direction, transport passengers or the like aboard the car between the plurality of floors. A plurality of the elevators 2 may be applied to a single building. In this example, the remote monitoring system 1 is applied to remote monitoring with a plurality of elevators 2 as objects of monitoring. Each of the elevators 2 is specified by, for example, a building number which specifies a building in which the elevator 2 is installed, an elevator number which specifies the elevator 2 in the building, and the like. In this example, each of the elevators 2 is specified by a unique property name.

An interphone 3 is provided in the car of each of the elevators 2. The interphone 3 is an intercommunication device used by a passenger aboard the car to engage in a voice call with the outside of the car or the like. The interphone 3 is used when, for example, a passenger becomes stuck in the car. The interphone 3 is connected to, for example, a first communication network 4. For example, the first communication network 4 is a wide-area communication network such as a telephone network. The first communication network 4 may be a communication network which spans a plurality of countries or regions.

The remote monitoring system 1 includes a plurality of remote monitoring devices 5. Each of the elevators 2 being an object of monitoring corresponds to any of the remote monitoring devices 5. The remote monitoring device 5 is a device for obtaining information of the elevator 2 which corresponds to the remote monitoring device 5. The remote monitoring device 5 is arranged in, for example, a building provided with the elevator 2 which corresponds to the remote monitoring device 5 or the like. Each of the remote monitoring devices 5 is connected to, for example, a second communication network 6. For example, the second communication network 6 is a wide-area communication network such as the Internet. The second communication network 6 may be a communication network which spans a plurality of countries or regions. The second communication network 6 may be a VPN (Virtual Private Network) on the Internet or the like.

The remote monitoring system 1 includes a central management device 7. The central management device 7 is made up of, for example, one or a plurality of server devices or the like. The one or a plurality of server devices making up the central management device 7 are arranged in an information center or the like. The information center is a hub where information on each of the elevators 2 being an object of monitoring is collected and managed. When the central management device 7 is made up of a plurality of server devices, a part of or all of the plurality of server devices may be arranged in mutually different buildings. In this case, each of the server devices being arranged in mutually different buildings communicates with one another via, for example, the second communication network 6. Alternatively, a part of or all of the functions of the central management device 7 may be implemented by a storage resource or a processing resource on a cloud service or the like. Operations of a remote management system are executed based on one or a plurality of programs installed on a device constituting the remote management system such as the central management device 7 or the remote monitoring device 5.

A plurality of operators engage in monitoring work using the remote monitoring system 1. Each of the operators engages in the monitoring work at, for example, the information center. Each operator performs the monitoring work through a calling device 8 and a monitoring terminal 9. For example, the calling device 8 is a telephone used in voice communication. The calling device 8 is connected to, for example, the first communication network 4. The monitoring terminal 9 is, for example, a general-purpose information terminal device such as a PC (Personal Computer). The monitoring terminal 9 receives information input by an operator, displays information to the operator, and the like. The monitoring terminal 9 is connected to the remote monitoring device 5 through, for example, a local network adopting wired communication or wireless communication. In the remote monitoring system 1, an account is issued for each of the operators. Each of the operators performs monitoring work using the remote management system by logging in as a user of the account issued to the operator. In this example, each of the users is specified by a unique user name.

A scope of authority with respect to monitoring work is set for each of the operators. The scope of authority with respect to monitoring work includes a monitoring range in which monitoring data can be browsed, a use period during which the monitoring range can be browsed, and a monitoring action which can be taken. The monitoring data is data used in the monitoring work such as information on each of the elevators 2 being an object of monitoring obtained in the remote monitoring device 5 or the like. The monitoring range is information representing a range of the elevator 2 being an object of monitoring. The monitoring range is represented as, for example, information listing elevators 2 which are objects of monitoring. Alternatively, the monitoring range may be represented as, for example, information representing conditions of designating the elevator 2 being an object of monitoring in a building in which the elevator 2 is installed, a region in which the building is located, or the like. The monitoring action is an action taken in the monitoring work performed through the remote monitoring system 1. For example, the monitoring action includes external communication with the outside of the remote monitoring system 1. For example, the external communication includes voice calls using the calling device 8. For example, voice calls as external communication include a call with a passenger of a car through the interphone 3 of the car, a call with a maintenance worker through a mobile phone 10 carried by the maintenance worker, and a call with a superintendent of the building in which the elevator 2 being an object of monitoring is installed. In the remote monitoring system 1, contents of settings with respect to each of the operators are managed in association with information of a user of the account issued to the operator.

In this case, when an operator is to become absent due to a business trip, a vacation, an absence from work, or the like, the operator may ask another operator to fill in to perform the monitoring work while the operator is absent. In addition, even when the operator is not absent, the operator may ask another operator to fill in to perform the monitoring work depending on a load status or the like. In such a case, the requesting operator registers a user of an account issued to the requested operator as a child user of the user of the account issued to the requesting operator. At this point, the user of the account issued to the requesting operator becomes a parent user of the user of the account issued to the requested operator. A scope of authority of the child user is set to a scope not exceeding a scope of authority of the parent user. In the remote monitoring system 1, such parent-child relationships between users are managed. The management of a parent-child relationship between users is executed based on, for example, a user management program installed on a device constituting the remote management system such as the central management device 7 or the like. The parent-child relationship between users may be any of one-to-one, one-to-many, many-to-one, and many-to-many. In addition, the parent-child relationship between users may include a multistage relationship such as a relationship with a grandchild user or, in other words, a child user of a child user.

The central management device 7 of the remote monitoring system 1 includes a storage part 11, a collecting part 12, a registration accepting part 13, a setting part 14, a registration canceling part 15, and a request processing part 16.

The storage part 11 is a portion which stores information. In this case, a part of or all of the storage part 11 may be arranged separated from the other portions of the central management device 7. At this point, the storage part 11 may be constituted of a single piece of hardware or constituted of a combination of a plurality of pieces of hardware. When the storage part 11 is constituted of a combination of a plurality of pieces of hardware, each piece of hardware may be selectively used depending on the information to be stored.

The storage part 11 stores information such as a monitoring data table, a user management table, and a child user management table. The monitoring data table is a table including information on elevators 2 obtained by each of the remote monitoring devices 5. The user management table is a table including information on a scope of authority with respect to the monitoring work by each user. The child user management table is a table including information on a scope of authority with respect to the monitoring work as a child user with respect to a user registered as a child user.

The collecting part 12 is a portion which collects information on elevators 2 obtained by each of the remote monitoring devices 5. The collecting part 12 collects information from each of the monitoring devices through the first communication network 4. For example, by accepting a report from each of the monitoring devices, the collecting part 12 collects information included in the report.

The registration accepting part 13 is a portion which accepts registration information. For example, the registration accepting part 13 accepts registration information through the monitoring terminal 9. The registration information is information representing registration of another user as a child user of any user. In this case, a user to be a parent user is an example of the first user. In addition, a user to be a child user is an example of the second user.

The setting part 14 is a portion which sets a scope of authority with respect to the monitoring work as a child user with respect to a user registered as a child user. The setting part 14 sets the scope of authority based on registration information of the child user accepted by the registration accepting part 13 and the scope of authority with respect to monitoring work of the parent user of the child user. The setting part 14 sets the scope of authority when the registration accepting part 13 accepts registration information. The setting part 14 includes an object setting part 17 and a period setting part 18. The object setting part 17 is a portion which sets an object of monitoring included in a monitoring range that can be browsed. The period setting part 18 is a portion which sets a use period during which the set monitoring range can be browsed.

The registration canceling part 15 is a portion which cancels a registration as a child user with respect to a user registered as a child user. The registration canceling part 15 may cancel registration based on, for example, information input through the monitoring terminal 9. Alternatively, the registration canceling part 15 may cancel registration based on the use period or the like set with respect to the child user.

The request processing part 16 is a portion which processes a request from a user through the monitoring terminal 9. For example, the request from the user includes a request to browse monitoring data or a request to take a monitoring action.

Next, an example of information stored in the storage part 11 will be described with reference to FIGS. 2 to 4.

FIG. 2 is a diagram showing an example of the monitoring data table which is stored in the storage part 11 according to the first embodiment. In the monitoring data table, for each object of monitoring, a property name of the object of monitoring and an incident of the object of monitoring are associated with each other. The incident is an event or the like which occurs in the elevator 2 being an object of monitoring. The incident is an example of information on the elevator 2 which is obtained by the remote monitoring device 5. Information on the incident is transmitted from the remote monitoring device 5 together with a property name of the elevator 2 upon, for example, an occurrence of the incident or the like. In addition, the incident is an example of monitoring data. Information on the incident includes information of a time of the occurrence of the incident. Information of the time of occurrence may be date information in days or time-of-day information in seconds. For example, the incident includes a start of monitoring and a report of an abnormality from the elevator 2 being an object of monitoring. In addition, the incident may include information on a measurement result of acceleration during a run of a car, information on an operation history of service floors of the car, and the like in the elevator 2 being an object of monitoring.

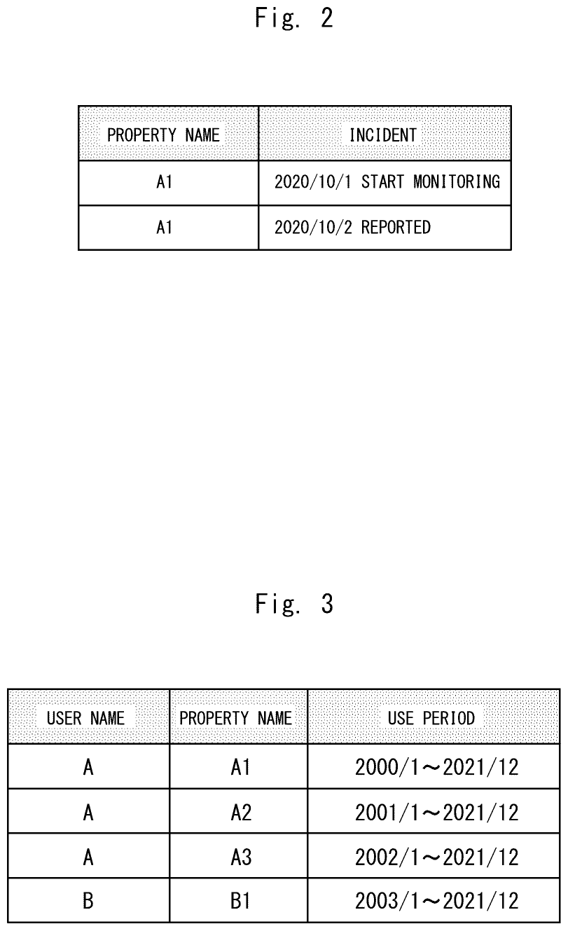

FIG. 3 is a diagram showing an example of the user management table which is stored in the storage part 11 according to the first embodiment. In the user management table, for each user, a user name of the user, a property name of an object of monitoring included in a monitoring range in which the user can browse monitoring data, and a use period during which monitoring data of the object of monitoring can be browsed are associated with each other. The use period may be, for example, information on a period in months, information of a period in days, hours, or minutes, or the like. The user management table is an example of the first table. A user whose user name is registered in the user management table may become a parent user of another child user.

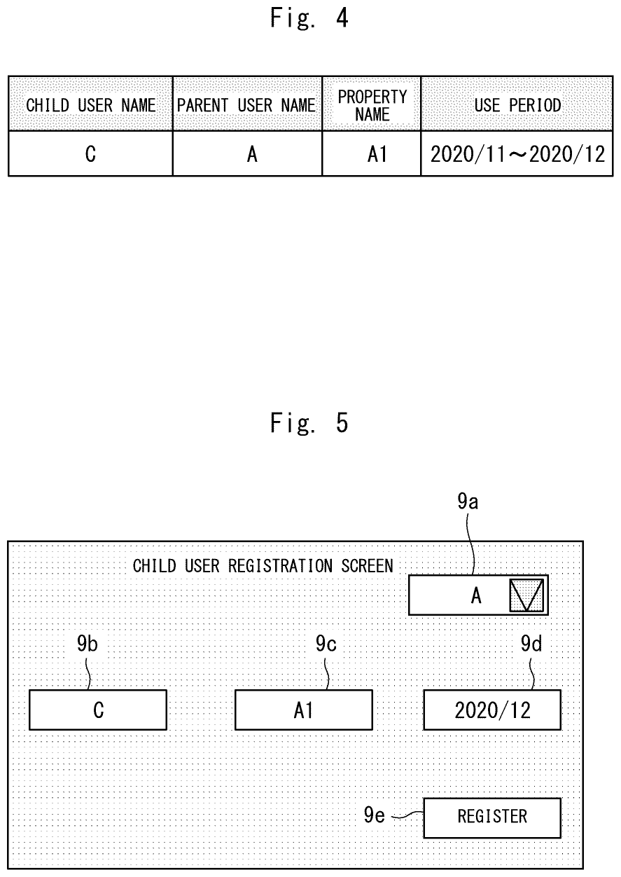

FIG. 4 is a diagram showing an example of the child user management table which is stored in the storage part 11 according to the first embodiment. In the child user management table, for each user registered as a child user, a user name of the user, a user name of a parent user of the user, a property name of an object of monitoring included in a monitoring range in which the user can browse monitoring data as a child user, and a use period during which monitoring data of the object of monitoring can be browsed are associated with each other. The child user management table is an example of the second table.

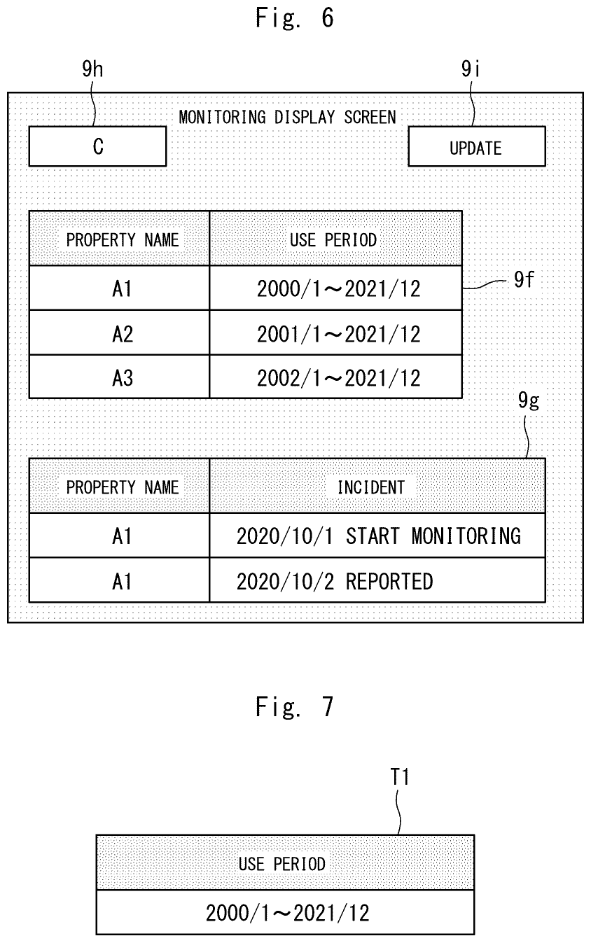

Next, an example of display on the monitoring terminal 9 will be described with reference to FIGS. 5 and 6.

FIGS. 5 and 6 are diagrams showing an example of display in the monitoring terminal 9 of the remote monitoring system 1 according to the first embodiment.

In FIG. 5, an example of display when registering a child user is shown. In this example, a user C is registered as a child user of a user A. On the monitoring terminal 9, a parent user selection box 9a, a child user input box 9b, an object designation box 9c, a period designation box 9d, and a registration button 9e are displayed. The parent user selection box 9a is an interface for selecting a user name of a user to be a parent user. For example, when a plurality of accounts are issued to an operator, the parent user selection box 9a is used to select one of the accounts to which a child user is to be registered as a user. In this example, the user A is selected as a parent user. The child user input box 9b is an interface for inputting a user name of the user to be registered as a child user of the selected user A. In this example, the user C is input as a child user. The object designation box 9c is an interface for designating an object of monitoring of which monitoring data can be browsed by the user C as a child user of the user A. An object of monitoring need not be designated in the object designation box 9c. The period designation box 9d is an interface for designating a use period during which monitoring data of an object of monitoring can be browsed by the user C as a child user of the user A. A use period need not be designated in the period designation box 9d. The registration button 9e is a button for executing registration of a child user. When the registration button 9e is pressed, information designated on the screen shown in FIG. 5 such as the user name of the parent user, the user name of the child user, a designation of the object of monitoring, and a designation of the use period are transmitted as registration information from the monitoring terminal 9 to the registration accepting part 13 of the central management device 7.

In FIG. 6, an example of display when an operator performs monitoring work is shown. In this example, the user C is performing monitoring work as a child user of the user A. On the monitoring terminal 9, a property list 9f, an incident list 9g, a user input box 9h, and an update button 9i are displayed. The property list 9f is a list displaying properties included in the monitoring range as a child user of the user C performing monitoring work. On the property list 9f, a use period as a child user of the user C with respect to each of the properties is also displayed. The incident list 9g is a list displaying incidents for each property included in the monitoring range as a child user of the user C performing monitoring work. The user input box 9h is an interface for inputting a user name of the user performing monitoring work. The update button 9i is a button for updating display of the property list 9f, the incident list 9g, and the like in accordance with the scope of authority of the user whose user name has been input to the user input box 9h. When the update button 9i is pressed, an update request is transmitted from the monitoring terminal 9 to the request processing part 16 of the central management device 7. The update request is an example of a request to browse monitoring data. For example, the update request includes information on a user name input to the user input box 9h.

Next, an example of registration of a child user will be described with reference to FIGS. 7 to 10.

FIGS. 7 to 10 are diagrams showing an example of a table which is processed in the remote monitoring system 1 according to the first embodiment.

When the registration button 9e is pressed on the screen shown in FIG. 5, the registration accepting part 13 accepts registration information from the monitoring terminal 9. At this point, the setting part 14 starts setting a scope of authority. The setting part 14 judges whether or not an object of monitoring and a use period are designated in the registration information.

When both the object of monitoring and the use period are designated, the setting part 14 judges whether or not the scope of authority according to the designated object of monitoring and the designated use period exceeds the scope of authority of the user designated as the parent user in the registration information. The setting part 14 obtains a table T1 of the use period illustrated in FIG. 7 by searching the user management table using the user name of the parent user and the designated object of monitoring as keys. The central management device 7 may refuse registration of the child user when the use period designated in the registration information exceeds the use period in the table T1. In addition, the central management device 7 may refuse registration of the child user even when a search comes up empty and the table T1 is blank or the like. On the other hand, when the use period designated in the registration information does not exceed the use period in the table T1, the setting part 14 registers information on the designated object of monitoring and the designated use period in the child user management table together with the user names of the parent user and the child user.

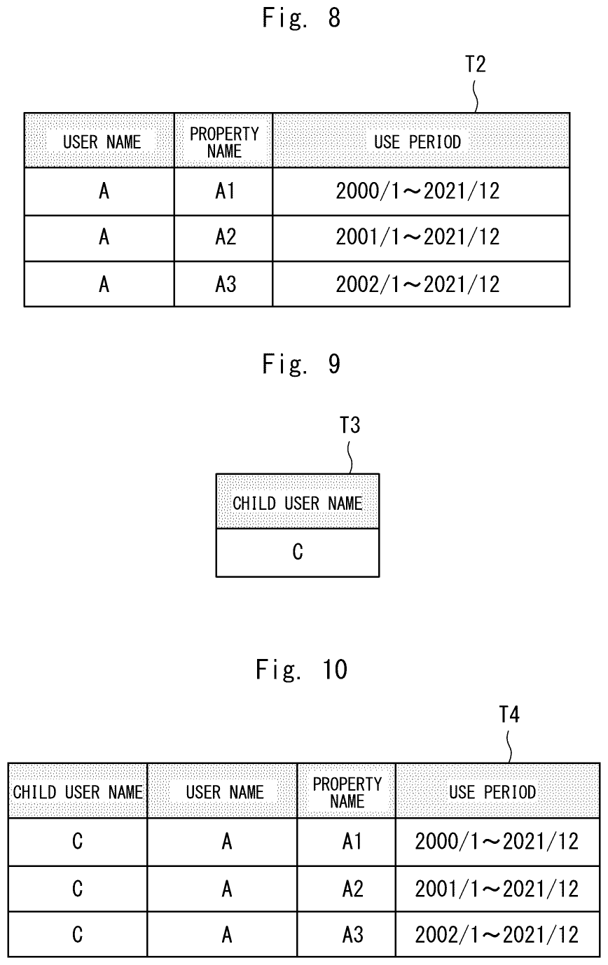

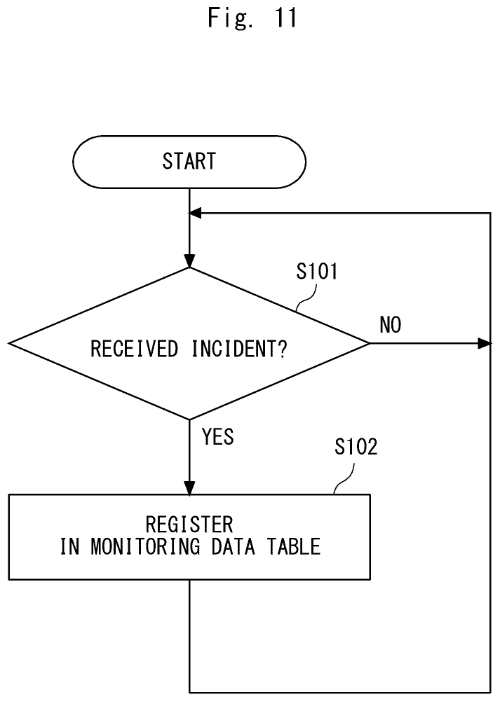

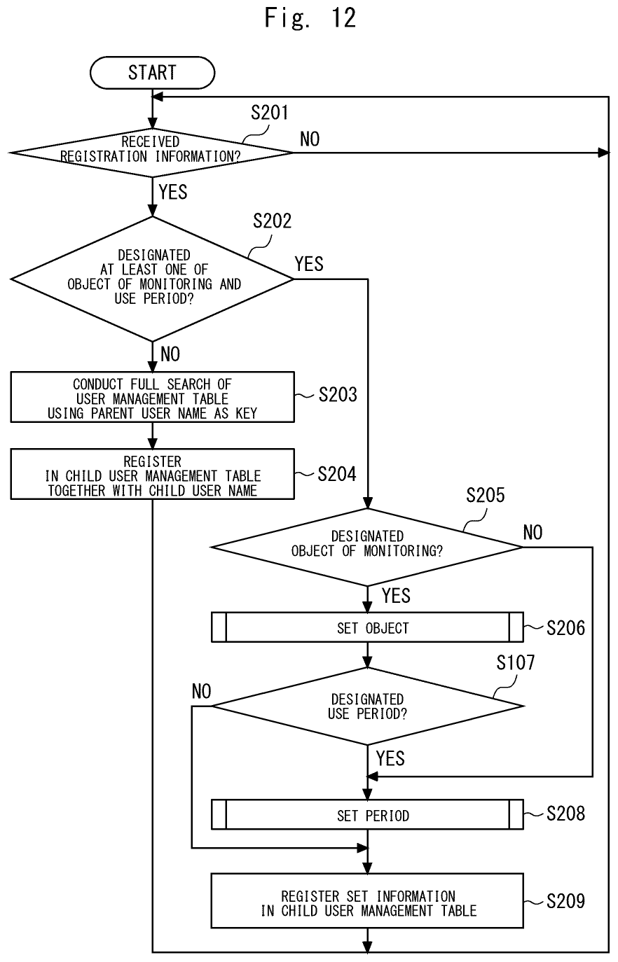

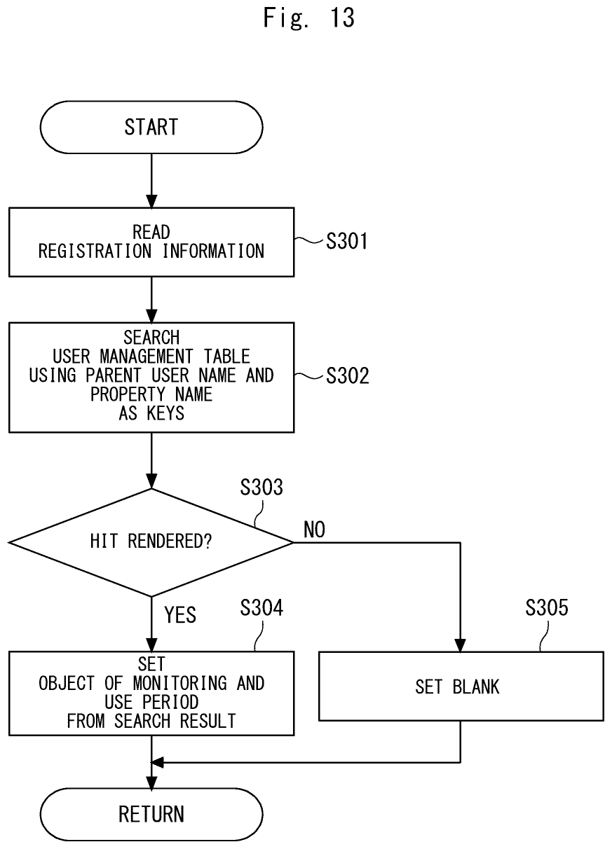

On the other hand, when both the object of monitoring and the use period are not designated, the setting part 14 sets the scope of authority of the child user based on the scope of authority of the user designated as the parent user in the registration information. By searching the user management table using the user name of the parent user as a key, the setting part 14 obtains a table T2 of the user name of the parent user, the property name, and the use period illustrated in FIG. 8. By taking a cross join of the obtained table T2 and a table T3 of the user name of the child user illustrated in FIG. 9, the setting part 14 generates a table T4 shown in FIG. 10. The setting part 14 registers the information in the generated table T4 in the child user management table.

In addition, when only the object of monitoring is designated, the setting part 14 obtains the table T1 of the use period by searching the user management table using the user name of the user registered as the parent user in the registration information and the designated object of monitoring as keys. The setting part 14 registers the information of the designated object of monitoring together with the obtained table T1 of the use period and the user names of the parent user and the child user to the child user management table.

Furthermore, when only the use period is designated, the setting part 14 obtains a table of the object of monitoring and the use period by searching the user management table using the user name of the user registered as the parent user in the registration information as a key and under a condition that the period designated in the registration information does not exceed the use period. The setting part 14 registers the information of the obtained table together with the user names of the parent user and the child user to the child user management table. Note that the central management device 7 may refuse registration of the child user when a search comes up empty and a table is blank or the like.

Next, an example of operations of the remote monitoring system 1 will be described with reference to FIGS. 11 to 16.

FIGS. 11 to 16 are flowcharts showing an example of operations of the remote monitoring system 1 according to the first embodiment.

FIG. 11 shows an example of an operation of the central management device 7 related to accumulation of monitoring data.

In step S101, the collecting part 12 judges whether or not a property name and information on an incident have been received from the remote monitoring device 5. When a judgment result is No, the central management device 7 once again advances to the processing of step S101. When a judgment result is Yes, the central management device 7 advances to processing of step S102.

In step S102, the collecting part 12 registers the received property name and the received information on an incident to the monitoring data table. Accordingly, monitoring data is accumulated in the monitoring data table. Subsequently, the central management device 7 advances to the processing of step S101.

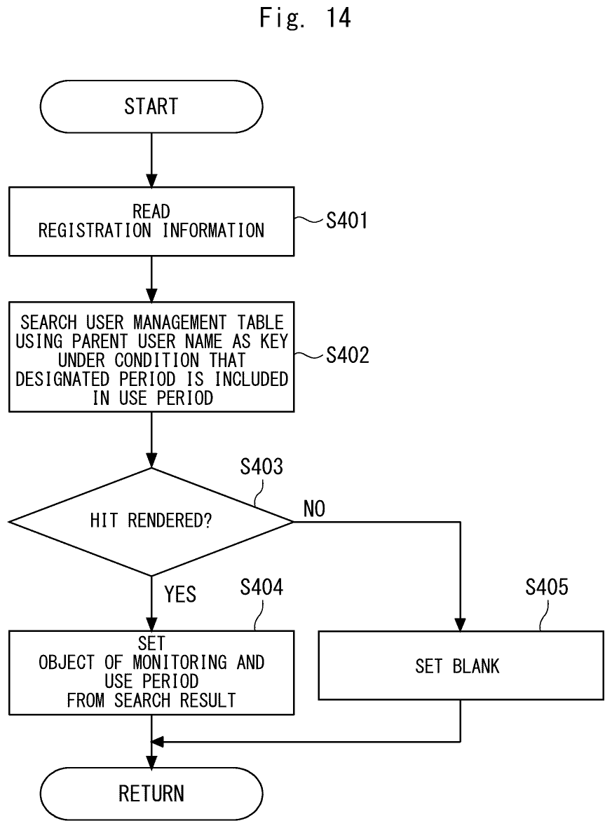

FIG. 12 shows an example of an operation of the central management device 7 related to registration of a child user.

In step S201, the registration accepting part 13 judges whether or not registration information has been received from the monitoring terminal 9. When a judgment result is No, the central management device 7 once again advances to the processing of step S201. When a judgment result is Yes, the central management device 7 advances to processing of step S202.

In step S202, the setting part 14 judges whether or not at least one of an object of monitoring and a use period has been designated in the registration information. When a judgment result is No, the central management device 7 advances to processing of step S203. When a judgment result is Yes, the central management device 7 advances to processing of step S205.

In step S203, by conducting a full search of the user management table using the user name of the parent user as a key, the setting part 14 obtains the table T2 of the user name of the parent user, the property name, and the use period. Subsequently, the central management device 7 advances to processing of step S204.

In step S204, by taking a cross join of the obtained table T2 and the table T3 of the user name of the child user, the setting part 14 generates the table T4. The setting part 14 registers the information in the generated table T4 to the child user management table. Subsequently, the central management device 7 advances to the processing of step S201.

In step S205, the setting part 14 judges whether or not an object of monitoring is designated in the registration information. When a judgment result is Yes, the central management device 7 advances to processing of step S206. When a judgment result is No, the central management device 7 advances to processing of step S208.

In step S206, the setting part 14 performs processing of object setting. In the processing of object setting, an object of monitoring not included in the monitoring range which the parent user can browse is removed from designated objects of monitoring. Subsequently, the central management device 7 advances to processing of step S207.

In step S207, the setting part 14 judges whether or not a use period is designated in the registration information with respect to the object of monitoring set in the processing of object setting. When a judgment result is Yes, the central management device 7 advances to processing of step S208. When a judgment result is No, with respect to the set object of monitoring, the setting part 14 sets the use period set in the processing of object setting without modification. Subsequently, the central management device 7 advances to processing of step S209. When a plurality of objects of monitoring with mutually different use periods have been set, the central management device 7 may perform processing of step S207 and thereafter for each of the objects of monitoring.

In step S208, the setting part 14 performs processing of period setting. Subsequently, the central management device 7 advances to the processing of step S209.

In step S209, the setting part 14 performs registration to the child user management table based on the scope of authority set to a child user. Subsequently, the central management device 7 advances to the processing of step S201.

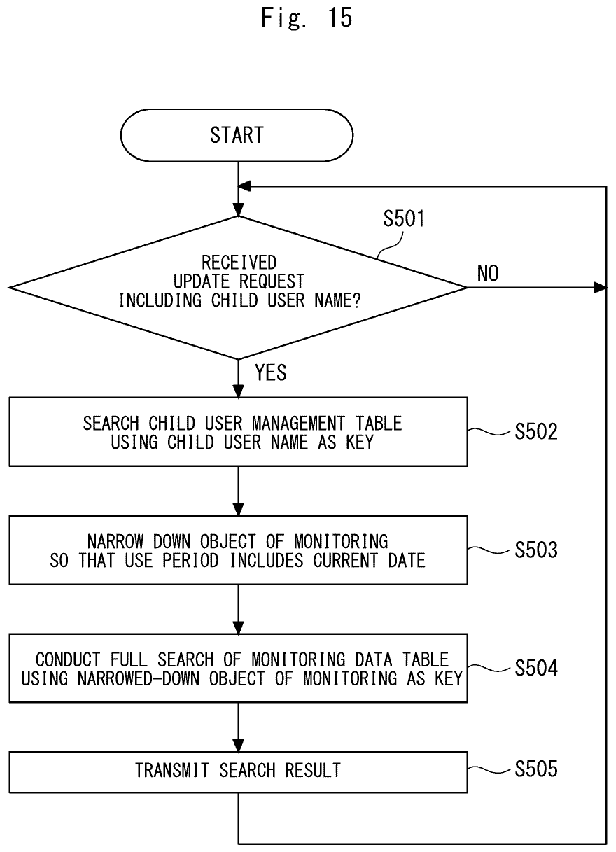

FIG. 13 shows an example of an operation of the central management device 7 related to processing of object setting.

In step S301, the object setting part 17 reads user names of a parent user and a child user and a property name of a designated object of monitoring from registration information. Subsequently, the central management device 7 advances to processing of step S302.

In step S302, the object setting part 17 searches the user management table using the read user name of the parent user and the read property name as keys. Subsequently, the central management device 7 advances to processing of step S303.

In step S303, the object setting part 17 judges whether or not a search result has been found or, in other words, whether the search rendered a hit. When a judgment result is Yes, the central management device 7 advances to processing of step S304. When a judgment result is No, the central management device 7 advances to processing of step S305.

In step S304, the object setting part 17 sets an object of monitoring included in a monitoring range that can be browsed by the child user based on the found search result. In addition, the object setting part 17 sets a use period to each object of monitoring based on the table T1 of the use period obtained as a search result. Subsequently, the central management device 7 ends processing of object setting.

In step S305, the object setting part 17 sets a blank to the monitoring range that can be browsed by the child user. Subsequently, the central management device 7 ends processing of object setting.

FIG. 14 shows an example of an operation of the central management device 7 related to processing of period setting.

In step S401, the period setting part 18 reads user names of a parent user and a child user and a designated use period from registration information. Subsequently, the central management device 7 advances to processing of step S402.

In step S402, the period setting part 18 searches the user management table using the read user name of the parent user as a key under a condition that the period designated in the registration information is included in the use period. Subsequently, the central management device 7 advances to processing of step S403.

In step S403, the period setting part 18 judges whether or not the search rendered a hit. When a judgment result is Yes, the central management device 7 advances to processing of step S404. When a judgment result is No, the central management device 7 advances to processing of step S405.

In step S404, the period setting part 18 sets an object of monitoring included in a monitoring range that can be browsed by the child user and a use period of the object of monitoring based on the found search result. Subsequently, the central management device 7 ends processing of period setting.

In step S405, the period setting part 18 sets a blank to the monitoring range that can be browsed by the child user and to the use period of the monitoring range. Subsequently, the central management device 7 ends processing of period setting.

FIG. 15 shows an example of an operation of the central management device 7 related to processing of a request from a user as a child user through the monitoring terminal 9.

In step S501, the request processing part 16 receives an update request and, at the same time, judges whether a user whose user name is included in the update request is registered as a child user in the child user management table. When a judgment result is No, the central management device 7 once again advances to the processing of step S501. When a judgment result is Yes, the central management device 7 advances to processing of step S502.

In step S502, the request processing part 16 searches the child user management table using the user name included in the update request as a key. Accordingly, the request processing part 16 obtains information on an object of monitoring of which monitoring data can be browsed by the child user and a use period of the object of monitoring. Subsequently, the central management device 7 advances to processing of step S503.

In step S503, the request processing part 16 obtains a current date. The request processing part 16 obtains a list of objects of monitoring of which the use period includes the current date among the objects of monitoring obtained from the child user management table. Subsequently, the central management device 7 advances to processing of step S504.

In step S504, the request processing part 16 conducts a full search of the monitoring data table using the property name of the object of monitoring included in the obtained list as a key. Accordingly, the request processing part 16 obtains a list of property names and incidents. Subsequently, the central management device 7 advances to processing of step S505.

In step S505, the request processing part 16 transmits the obtained list to the monitoring terminal 9 to cause the list to be displayed as the incident list 9g on the monitoring terminal 9. Subsequently, the central management device 7 advances to the processing of step S501.

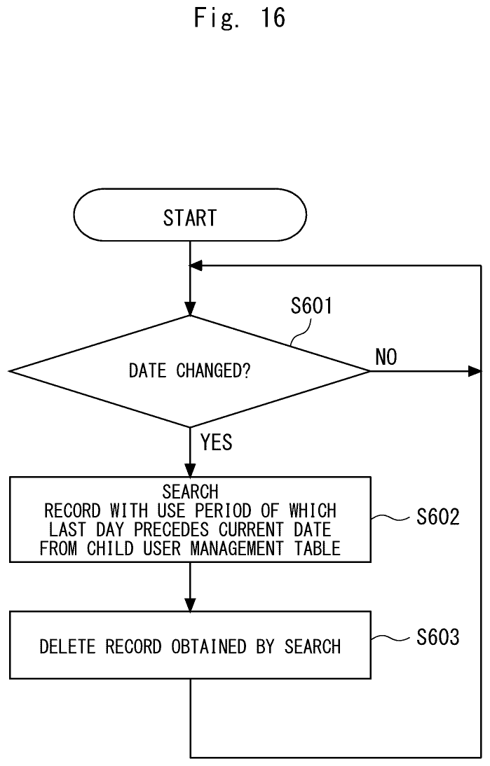

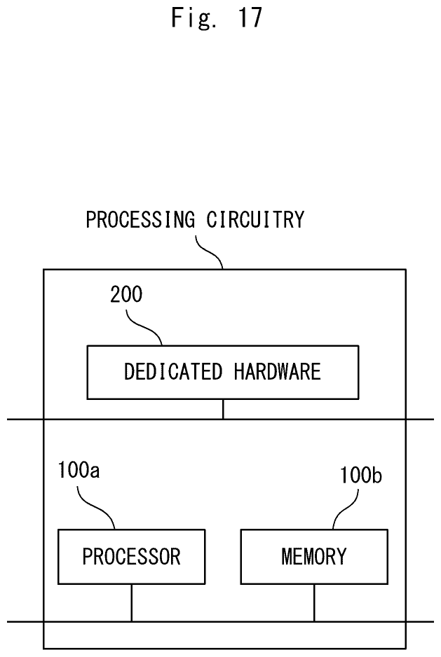

FIG. 16 shows an example of an operation of the central management device 7 related to canceling the registration of a child user.

In step S601, the registration canceling part 15 obtains a current date. The registration canceling part 15 judges whether the date has changed from a previously obtained date to the current date. When a judgment result is No, the central management device 7 once again advances to the processing of step S601. When a judgment result is Yes, the central management device 7 advances to processing of step S602.

In step S602, the registration canceling part 15 searches a record with a use period of which a last day precedes the current date from the child user management table. Subsequently, the central management device 7 advances to processing of step S603.

In step S603, the registration canceling part 15 deletes records obtained as search results from the child user management table. In this case, the registration of any child user is canceled when all of the records with respect to the child user are deleted. Subsequently, the central management device 7 advances to the processing of step S601.

Note that, in the remote monitoring system 1, the scope of authority with respect to monitoring work need not be directly set with respect to a user associated with an account. For example, the scope of authority with respect to monitoring work may be set to a role. A role is assigned to a user.

In addition, even when any user is registered as a child user of another user, a scope of authority unique to the child user set in the user management table need not be particularly limited. In other words, with respect to an object of monitoring with a property name Cl which cannot be browsed by the user A, the user C may be capable of browsing monitoring data before being registered as a child user. In this case, even when the user C is registered as the child user of the user A, browsing of the monitoring data of the object of monitoring with the property name Cl by the user C need not be limited.

In addition, the information center may be a hub for collecting and managing information on elevators 2 being installed across a plurality of countries or regions. In other words, a country or a region where the central management device 7 in the information center or the like is installed and a country or a region where each of the elevators 2 is installed may differ from each other. Relay stations and the like in the first communication network 4 may be arranged across a plurality of countries or regions. Nodes and the like in the second communication network 6 may be arranged across a plurality of countries or regions. Both the first communication network 4 and the second communication network 6 may be communication networks which perform digital communication such as the Internet. In this case, the first communication network 4 and the second communication network 6 may be a same communication network. When the central management device 7 installed in a first country or region collects information from the elevator 2 installed in a second country or region, the first communication network 4 or the second communication network 6 may be a communication network including a relay station or a node installed in a third country or region. The third country or region which includes the relay station or the node of the first communication network 4 or the second communication network 6 may include a plurality of countries or regions. In this manner, the present disclosure also contemplates the remote monitoring system 1 in which communication via the first communication network 4, the second communication network 6, and the like which connect the plurality of elevators 2, the plurality of remote monitoring devices 5, the central management device 7, and the like is performed across a plurality of countries or regions.

In addition, the central management device 7 may be a system being installed across a plurality of countries or regions. For example, when the central management device 7 is constituted of a plurality of server devices, the respective server devices may be arranged in mutually different countries or regions. For example, when a server device mounted with a partial function such as the storage part 11 among the functions of the central management device 7 is arranged in the first country or region, a server device mounted with another function may be arranged in the second country or region or the like.

Furthermore, when a part of the central management device 7 such as the storage part 11 is constituted of a combination of a plurality of pieces of hardware, the respective pieces of hardware may be arranged in mutually different countries or regions. For example, when a piece of hardware for storing the monitoring data table among the storage part 11 is arranged in the first country or region, a piece of hardware for storing the user information table may be arranged in the second country or region. In this case, a piece of hardware for storing the child user information table may be arranged in the third country or region.

As described above, the remote monitoring system 1 according to the first embodiment includes the registration accepting part 13 and the setting part 14. The registration accepting part 13 accepts registration information. Registration information represents registration of a second user as a child user of a first user being registered in the user management table. The first table associates a browsable monitoring range with each user. When the registration accepting part 13 accepts registration information, the setting part 14 sets a monitoring range which can be browsed by the second user as a child user of the first user to a range not exceeding a browsable monitoring range which is associated with the first user in the user management table. In addition, the remote monitoring system 1 includes the storage part 11. The storage part 11 stores the first table. In addition, the storage part 11 stores the second table. The second table associates the browsable monitoring range set by the setting part 14 with a child user registered based on the registration information.

Furthermore, a user management method according to the first embodiment includes a registration accepting step and a setting step. The registration accepting step is a step of accepting registration information. Based on the registration information accepted in the registration accepting step, the setting step sets a monitoring range which can be browsed by the second user as a child user of the first user to a range not exceeding a browsable monitoring range which is associated with the first user in the user management table.

In addition, a user management program according to the first embodiment causes the remote monitoring system 1 of the elevator 2 to execute a registration accepting step and a setting step.

According to such a configuration, a child user having inherited the scope of authority held by a parent user can be readily registered. In this case, new registration of a permanent and independent user is not required. In addition, since excessive authority is not granted to an operator who fills in to perform monitoring work by accessing the remote monitoring system 1 as a child user, security of information is less likely to decline. As described above, since a user can be readily registered as a child user vested with an appropriate scope of authority based on the scope of authority of an existing user, it is easy to fill in to perform monitoring work of the elevator 2.

In addition, the registration information may include a designation of an object of monitoring included in a monitoring range which can be browsed by the second user. In this case, the setting part 14 sets the monitoring range which can be browsed by the second user as a child user of the first user as follows. The monitoring range is limited to an object of monitoring which is associated with the first user as a browsable monitoring range in the user management table and which is designated in registration information.

Furthermore, the registration information may include a designation of a use period. In this case, the setting part 14 sets the monitoring range which can be browsed by the second user as a child user of the first user as follows. The monitoring range is limited to an object of monitoring which is associated with the first user as a browsable monitoring range in the user management table and to which the browsable use period designated for the first user in the user management table includes the use period designated in registration information. The setting part 14 sets a period during which the second user as a child user of the first user can browse the object of monitoring to the use period designated in the registration information.

According to such a configuration, the scope of authority granted to the second user as a child user is set in accordance with a designated range and the scope of authority granted to the first user being the parent user so as not to exceed the scope of authority of the first user. Accordingly, security of information due to filling in to perform monitoring work is less likely to decline.

Furthermore, the registration information may not include a designation of an object of monitoring. In this case, the setting part 14 sets the monitoring range which can be browsed by the second user as a child user of the first user as follows. The monitoring range is limited to an object of monitoring which is associated with the first user as a browsable monitoring range in the user management table.

In addition, the registration information may not include a designation of a use period. In this case, the setting part 14 sets the monitoring range which can be browsed by the second user as a child user of the first user as follows. The monitoring range is limited to an object of monitoring which is associated with the first user as a browsable monitoring range in the user management table. The setting part 14 sets a period during which the second user as a child user of the first user can browse the object of monitoring to the use period during which the object of monitoring is browsable which is designated for the first user in the user management table.

According to such a configuration, even when a designation of the scope of authority is omitted upon registration of a child user, the scope of authority granted to the second user as the child user is set in accordance with the scope of authority granted to the first user so as not to exceed the scope of authority. Accordingly, security of information due to filling in to perform monitoring work is less likely to decline. In addition, since an explicit designation of a scope of authority such as inputting an individual property name to be an object of monitoring can be omitted, it is easy to fill in to perform monitoring work of the elevator 2.

Furthermore, the remote monitoring system 1 includes the registration canceling part 15. When use periods set by the setting part 14 as periods during which a set monitoring range of the second user as a child user of the first user is browsable all expire, the registration canceling part 15 cancels the registration of the second user as the child user of the first user.

According to such a configuration, since the registration of the child user of which a use period has expired is canceled, unnecessary registrations of child users are less likely to accumulate. Therefore, unauthorized access due to hijacking of an unused user account or the like is prevented. Accordingly, security of information is less likely to decline.

The registration information may include a restriction on monitoring actions which the second user as the child user of the first user can take. In this case, the setting part 14 may limit the monitoring actions which can be taken by the second user as a child user of the first user to a restricted range in the registration information.

In addition, the first table such as the user management table may associate a monitoring action which can be taken with each user. At this point, the setting part 14 may set the monitoring action which can be taken by the second user as the child user of the first user so as not to exceed a range of monitoring actions which can be taken and which is associated with the first user in the user management table.

In this case, for example, the registration information includes propriety of external communication as a restriction on monitoring actions which can be taken. In addition, for example, as the propriety of external communication, registration information includes propriety of a voice call through an intercommunication device provided in an object of monitoring. At this point, for example, a restriction is imposed on actions of the calling device 8 or the like through the monitoring terminal 9, the central management device 7, or the like.

According to such a configuration, an operator requested to fill in can be restricted from taking unnecessary monitoring actions. For example, the operator requested to fill in may be a member of an external organization entrusted to carry out a part of the monitoring work. In such a case, the requested operator may not be permitted to perform external communication such as voice calls. In this manner, even when a range of monitoring action is restricted for each operator, a restriction can be imposed on monitoring action through the registration of a child user.

In addition, an update request may be a request to designate a property name of an object of monitoring and to display monitoring data of the object of monitoring. In such a case, when the request processing part 16 of the remote monitoring system 1 receives a request from the second user as a child user of the first user for browsing which exceeds the monitoring range set by the setting part 14 to a child user of the first user, the request processing part 16 refuses the request.

According to such a configuration, unauthorized access to data of an object of monitoring by a user not authorized to browse the object of monitoring is prevented. Accordingly, security of information is less likely to decline.

Next, an example of a hardware configuration of the remote monitoring system 1 will be described with reference to FIG. 17.

FIG. 17 is a hardware configuration diagram of substantial parts of the remote monitoring system 1 according to the first embodiment.

Each function of the remote monitoring system 1 can be realized by a processing circuit. The processing circuit includes at least one processor 100a and at least one memory 100b. The processing circuit may include at least one piece of dedicated hardware 200 together with, or in place of, the processor 100a and the memory 100b.

When the processing circuit includes the processor 100a and the memory 100b, each function of the remote monitoring system 1 is realized by software, firmware, or a combination of software and firmware. At least one of the software and the firmware is described as a program. The program is stored in the memory 100b. The processor 100a realizes each function of the remote monitoring system 1 by reading and executing the program stored in the memory 100b.

The processor 100a is also referred to as a CPU (Central Processing Unit), a processing unit, an arithmetic unit, a microprocessor, a microcomputer, or a DSP. The memory 100b is constituted of, for example, a non-volatile or volatile semiconductor memory such as a RAM, a ROM, a flash memory, an EPROM, or an EEPROM.

When the processing circuit includes the piece of dedicated hardware 200, for example, the processing circuit is realized by a single circuit, a combined circuit, a programmed processor, a parallel-programmed processor, an ASIC, an FPGA, or a combination thereof.

Each function of the remote monitoring system 1 can be individually realized by a processing circuit. Alternatively, respective functions of the remote monitoring system 1 can be collectively realized by a processing circuit. With respect to the respective functions of the remote monitoring system 1, a part of the functions may be realized by the piece of dedicated hardware 200 while other parts may be realized by software or firmware. In this manner, the processing circuit realizes each function of the remote monitoring system 1 using the dedicated hardware 200, software, firmware, or a combination thereof.

### INDUSTRIAL APPLICABILITY

The remote monitoring system according to the present disclosure can be applied to remote monitoring of an elevator. The user management method and the user management program according to the present disclosure can be applied to the remote monitoring system.

### REFERENCE SIGNS LIST

1 Remote monitoring system, 2 Elevator, 3 Interphone, 4 First communication network, 5 Remote monitoring device, 6 Second communication network, 7 Central management device, 8 Calling device, 9 Monitoring terminal, 10 Mobile phone, 11 Storage part, 12 Collecting part, 13 Registration accepting part, 14 Setting part, 15 Registration canceling part, 16 Request processing part, 17 Object setting part, 18 Period setting part, 9a Parent user selection box, 9b Child user input box, 9c Object designation box, 9d Period designation box, 9e Registration button, 9f Property list, 9g Incident list, 9h User input box, 9i Update button, 100a Processor, 100b Memory, 200 Dedicated hardware.

1. A remote elevator monitoring system, comprising:
processing circuitry
to accept registration information representing registration of a second user as a child user of a first user being registered in a first table which associates a browsable monitoring range with each of a plurality of users; and
to set, when the registration information is accepted, a monitoring range which can be browsed by the second user as a child user of the first user to a range not exceeding a browsable monitoring range which is associated with the first user in the first table.

2. The remote elevator monitoring system according to claim 1, wherein
when the registration information includes a designation of an object of monitoring included in a browsable monitoring range of the second user, the processing circuitry limits the monitoring range which can be browsed by the second user as a child user of the first user to an object of monitoring which is associated with the first user as a browsable monitoring range in the first table and which is designated in the registration information.

3. The remote elevator monitoring system according to claim 1, wherein
when the registration information does not include a designation of an object of monitoring, the processing circuitry limits the monitoring range which can be browsed by the second user as a child user of the first user to an object of monitoring which is associated with the first user as a browsable monitoring range in the first table.

4. The remote elevator monitoring system according to claim 1, wherein
when the registration information includes a designation of a use period, the processing circuitry limits a monitoring range which can be browsed by the second user as a child user of the first user to an object of monitoring which is associated with the first user as a browsable monitoring range in the first table and to which a browsable use period designated for the first user in the first table includes the use period designated in the registration information, and the processing circuitry sets a browsable period to the object of monitoring to the use period designated in the registration information.

5. The remote elevator monitoring system according to claim 1, wherein
when the registration information does not include a designation of a use period, the processing circuitry limits a monitoring range which can be browsed by the second user as a child user of the first user to an object of monitoring which is associated with the first user as a browsable monitoring range in the first table, and the processing circuitry sets a browsable period to the object of monitoring to a browsable use period to the object of monitoring designated for the first user in the first table.

6. The remote elevator monitoring system according to claim 4, wherein
the processing circuitry cancels, when a use period set as a period during which a set monitoring range of the second user as a child user of the first user is browsable expires, the registration of the second user as the child user of the first user.

7. The remote elevator monitoring system according to claim 1, wherein
when the registration information includes a restriction on monitoring actions which can be taken, the processing circuitry limits monitoring actions which can be taken by the second user as a child user of the first user to a restricted range in the registration information.

8. The remote elevator monitoring system according to claim 7, wherein
the registration information includes propriety of external communication as a restriction on monitoring actions which can be taken.

9. The remote elevator monitoring system according to claim 8, wherein
as the propriety of external communication, registration information includes propriety of a voice call through an intercommunication device provided in an object of monitoring.

10. The remote elevator monitoring system according to claim 1, wherein
when a request for browsing which exceeds the monitoring range set to a child user of the first user is received from the second user as a child user of the first user, processing circuitry refuses the request.

11. A remote elevator monitoring system, comprising:
processing circuitry
to store a first table which associates a browsable monitoring range with each of a plurality of users;
to accept registration information representing registration of a second user as a child user of a first user being registered in the first table; and
to set, when the registration information is accepted, a monitoring range which can be browsed by the second user as a child user of the first user to a range not exceeding a browsable monitoring range which is associated with the first user in the first table.

12. A remote elevator monitoring system, comprising:
processing circuitry
to accept registration information representing registration of a second user as a child user of a first user being registered in a first table which associates a browsable monitoring range with each of a plurality of users;
to set, when the registration information is accepted, a monitoring range which can be browsed by the second user as a child user of the first user to a range not exceeding a browsable monitoring range which is associated with the first user in the first table; and
to store a second table which associates a browsable monitoring range with a child user registered based on the registration information.

13. A user management method in a remote elevator monitoring system, comprising:
accepting registration information representing registration of a second user as a child user of a first user being registered in a first table which associates a browsable monitoring range with each of a plurality of users; and
setting, based on the accepted registration information, a monitoring range which can be browsed by the second user as a child user of the first user to a range not exceeding a browsable monitoring range which is associated with the first user in the first table.

14. A storage medium storing a user management program causing a remote elevator monitoring system to execute:
accepting registration information representing registration of a second user as a child user of a first user being registered in a first table which associates a browsable monitoring range with each of a plurality of users; and
setting, based on the accepted registration information, a monitoring range which can be browsed by the second user as a child user of the first user to a range not exceeding a browsable monitoring range which is associated with the first user in the first table.
